(19) United States
(12) Patent Application Publication
(10) Pub. No.: US 2013/0262388 A1
(43) Pub. Date: Oct. 3, 2013

(54) DATABASE BACKUP TO HIGHEST-USED PAGE

(71) Applicants: Ellen L. Sorenson, Mounds View, MN (US); Roger V. Ritchie, Colorado Springs, CO (US)

(72) Inventors: Ellen L. Sorenson, Mounds View, MN (US); Roger V. Ritchie, Colorado Springs, CO (US)

(21) Appl. No.: 13/435,230

(22) Filed: Mar. 30, 2012

(51) Int. Cl. G06F 17/30

(52) U.S. Cl. 707/640; 707/E17.005

(57) ABSTRACT

Database backup performance may be improved by copying only used portions of a database file. When the database file includes allocated but un-used pages, the unused pages are not replicated during a database backup. By replicating only the allocated and used pages in the database, the backup time may be decreased and the amount of storage required in the second file may be decreased.

The instant disclosure relates to computer backup systems. More specifically, this disclosure relates to database backup systems.

### BACKGROUND

Data in a database file may be stored on a physical storage device, such as a tape drive or a hard disk drive, in bits. Each bit occupies a physical location on the storage device, and an allocation table tracks which bits are assigned to particular files stored on the storage device. The amount of physical storage space allocated to a database file is often more than the amount of actual data stored by the database. The allocated space is larger than the stored data to accommodate growth in the database file. That is, when new data is added to the database, space has already been reserved and the data may be stored in the allocated but unused bits. If instead no allocated and unused space remained available, the the storage device would be required to locate additional storage space, update the allocation table, and then store the data. Thus, allocating additional unused space to a file reduces write times for later modifying the database file.

FIG. 1 is a block diagram illustrating a conventional storage device including used and unused allocated bits for a file. A storage device 100 includes a number of bits 110a-x grouped into a page 102. The bits 110a-x may be grouped into bytes, in which each byte is 8 bits. The page 102 may include, for example 512 bytes, or 4096 bits. The page 102 may store data as a sequence of 1's and 0's. Each of the pages 104 and 106 may include additional data that combined with the page 102 make up a database file. A page 108 may also be allocated to the database file but not store any data for the database file. Instead, the page 108 is available for storing new data in the database file.

When backups of the database file are performed, the entire database file is copied from the physical storage device to a second physical storage device. When the database file includes a large amount of allocated but unused space, the backup process may consume a large amount of resources to backup unused space. For example, in some cases the allocated and unused space may be as much as or larger than the allocated and used space.

### SUMMARY

According to one embodiment, a method includes identifying a first file for backup. The method also includes identifying a portion of the first file containing user data. The method further includes copying the user data portion of the first file to a second file.

According to another embodiment, a computer program product includes a non-transitory computer readable medium having code to identify a first file for backup. The medium also includes code to identify a portion of the first file containing user data. The medium further includes code to copy the user data portion of the first file to a second file.

According to a further embodiment, an apparatus includes a memory for storing a database. The apparatus also includes a processor coupled to the memory. The processor is configured to identify a first file of the database for backup. The processor is also configured to identify a portion of the first file containing user data. The processor is further configured to copy the user data portion of the first file to a second file.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a conventional storage device including used and unused allocated bits for a file.

FIG. 2 is a flow chart illustrating a method for backing up allocated and used portions of a file according to one embodiment of the disclosure.

FIG. 3 is a block diagram illustrating a backup system for a database system according to one embodiment of the disclosure.

FIG. 4 is a flow chart illustrating a method for backing up allocated and used portions of a file according to another embodiment of the disclosure.

FIG. 5 is block diagram illustrating a computer network according to one embodiment of the disclosure.

FIG. 6 is a block diagram illustrating a computer system according to one embodiment of the disclosure.

FIG. 7A is a block diagram illustrating a server hosting an emulated software environment for virtualization according to one embodiment of the disclosure.

FIG. 7B is a block diagram illustrating a server hosing an emulated hardware environment according to one embodiment of the disclosure.

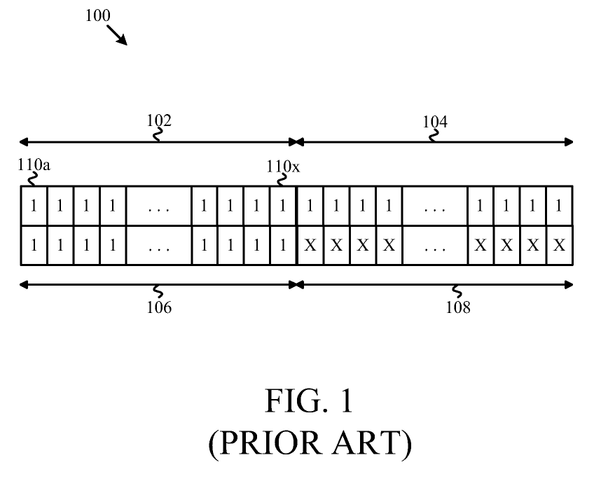

### DETAILED DESCRIPTION

Backup performance may be improved by identifying the portion of a database file that is allocated and used, and backing up only the allocated and used portion of the file. Thus, the portion of the file that is allocated but unused is not backed up. The reduced amount of data for backing up may reduce the amount of time a backup consumes and may reduce the amount of total storage space required of backup devices. That is, by backing up less data, the backups complete quicker and consume less space on a second storage device.

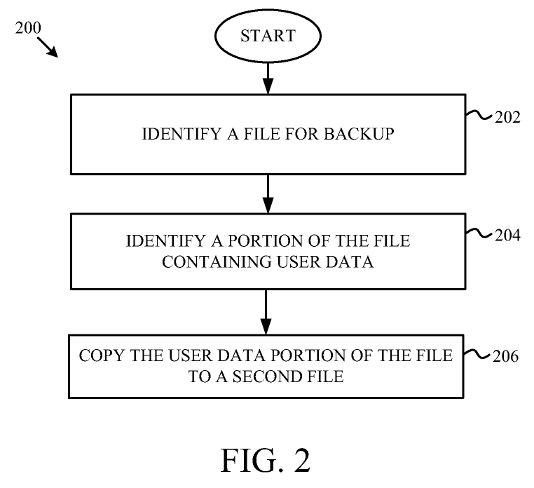

FIG. 2 is a flow chart illustrating a method for backing up allocated and used portions of a file according to one embodiment of the disclosure. A method 200 begins at block 202 with identifying a first file on a first storage device for backup to a second file. The first file may be, for example, a relational database management system (RDMS) file.

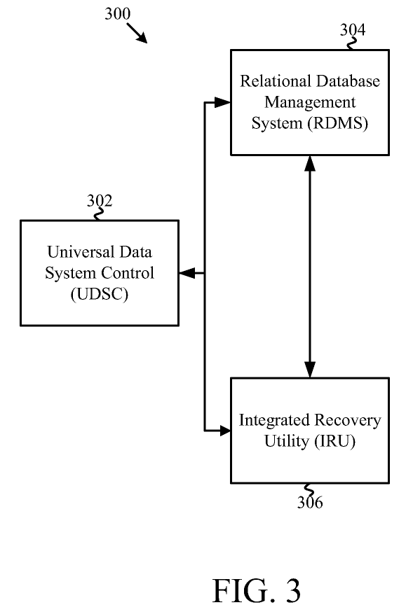

A database and associated components for backing up the database are illustrated in FIG. 3. FIG. 3 is a block diagram illustrating a backup system for a database system according to one embodiment of the disclosure. A RDMS 304 may be coupled to an intergrated recovery utility (IRU) 306 for performing backups and/or recovery of a database file in the RDMS 304. A universal data system control (UDSC) 302 may be coupled to the RDMS 304 and the IRU 306 to control backup and/or other file operations. The IRU 306 may perform backups of the RDMS 304 under control of the UDSC 302.

Referring back to FIG. 2 at block 204, a portion of the file containing user data is identified. The portion of the first file in the RDMS 304 of FIG. 3 that is allocated and unused may be identified by a function in the RDMS 304 to identify the highest used page in the first file. The RDMS 304 may execute the highest-used-page function under control of the UDSC 302 and return the highest-used page number to the UDSC 302. The highest-used page function may identify the pages using a number of allocation blocks within the file. The highest-used-page function may read one or more allocation pages into a buffer and analyze the pages to determine the highest-used page. According to one embodiment, five or eight allocation pages may be read by the function. The UDSC 302 then passes the page information to the IRU 306.

According to one embodiment, the first file in the RDMS 304 may not be stored in contiguous pages. That is, some pages may include both allocated and used bits and allocated and unused bits. When the use is not contiguous throughout the pages of the first file, the highest-used-page function of the RDMS 304 may return the number of the highest page containing any used bits. Thus, all of the user data in the first file is backed up, even at the expense of backing up some unused bits.

At block 206, the user data portion of the first file identified at block 204 is copied to a second file on a second storage device. The second storage device receives a copy of the user data of the first file through a data dump from the RDMS 304 to the IRU 306.

According to one embodiment, the IRU 306 saves a recovery-start time when the IRU 306 begins receiving a data dump from the RDMS 304. If a file is unavailable or read-only, the IRU 306 saves a current system time and proceeds with a static data dump. Otherwise, the IRU 306 may determine the data dump is dynamic and call the UDSC 302 to determine a start time of the oldest update thread, which the IRU 306 may save as the recovery-start time. When a data dump is limited to the highest-used page, the IRU 306 may obtain a recovery-start time before the file is read to determine the highest-used page. Thus, a recovery performed after reloading a dynamic data dump may access audit records for higher pages inserted into the file while the IRU 306 was performing the data dump.

According to one embodiment, the first and second storage devices described in the method of FIG. 2 may be virtualized storage devices. That is, the first storage device may span a number of physical and/or logical storage devices. Likewise, the second storage device may span a number of physical and/or logical storage devices.

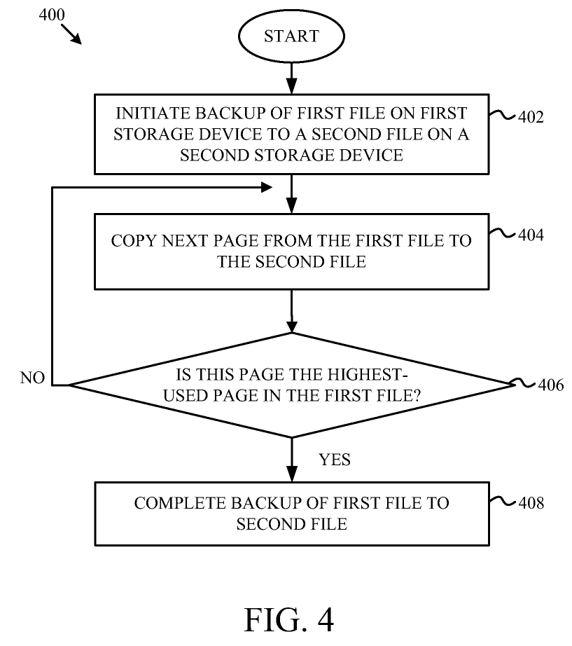

FIG. 4 is a flow chart illustrating a method for backing up allocated and used portions of a file according to another embodiment of the disclosure. A method 400 begins at block 402 with initiating a backup of a first file on a first storage device to a second file on a second storage device. The initiation may include for example, saving a recovery-start time. At block 404, a page of the first file is copied to the second file. At block 406, it is determined whether the last-copied page at block 404 is the highest-used page in the first file. If the page copied at block 404 is not the highest-used page, then the method 400 returns to block 404 to copy another page from the first file to the second file. When the page copied at block 404 is the highest-used page, then the method 400 continues to block 408 to complete the backup of the first file to the second file. Block 408 may include, for example, closing the first file and closing the second file.

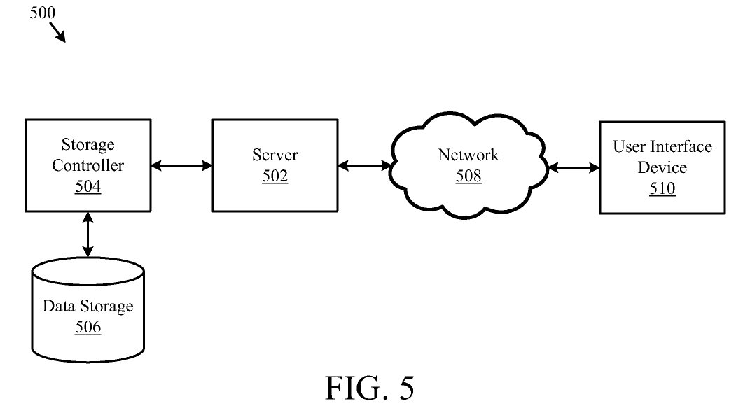

FIG. 5 illustrates one embodiment of a system 500 for an information system, such as a system for backing up databases. The system 500 may include a server 502, a data storage device 506, a network 508, and a user interface device 510. The server 502 may be a dedicated server or one server in a cloud computing system. In a further embodiment, the system 500 may include a storage controller 504, or storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other a mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and provide a user interface for enabling a user to enter or receive information.

The network 508 may facilitate communications of data, such as authentication information, between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the user interface device 510 accesses the server 502 through an intermediate sever (not shown). For example, in a cloud application the user interface device 510 may access an application server. The application server fulfills requests from the user interface device 510 by accessing a database management system (DBMS), which stores authentication information and associated action challenges. In this embodiment, the user interface device 510 may be a computer or phone executing a Java application making requests to a JBOSS server executing on a Linux server, which fulfills the requests by accessing a relational database management system (RDMS) on a mainframe server.

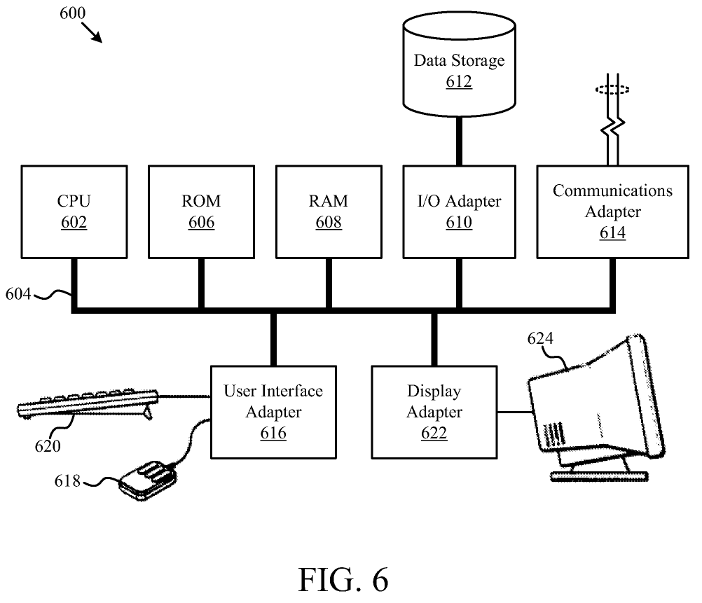

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the modules and operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), and the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 508, which may be one or more of a LAN, WAN, and/or the Internet. The communications adapter 614 may also be adapted to couple the computer system 600 to other networks such as a global positioning system (GPS) or a Bluetooth network. The user interface adapter 616 couples user input devices, such as a keyboard 620, a pointing device 618, and/or a touch screen (not shown) to the computer system 600. The keyboard 620 may be an on-screen keyboard displayed on a touch panel. Additional devices (not shown) such as a camera, microphone, video camera, accelerometer, compass, and or gyroscope may be coupled to the user interface adapter 616. The display adapter 622 may be driven by the CPU 602 to control the display on the display device 624. Any of the devices 602-622 may be physical, logical, or conceptual.

The applications of the present disclosure are not limited to the architecture of computer system 600. Rather the computer system 600 is provided as an example of one type of computing device that may be adapted to perform the functions of a server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

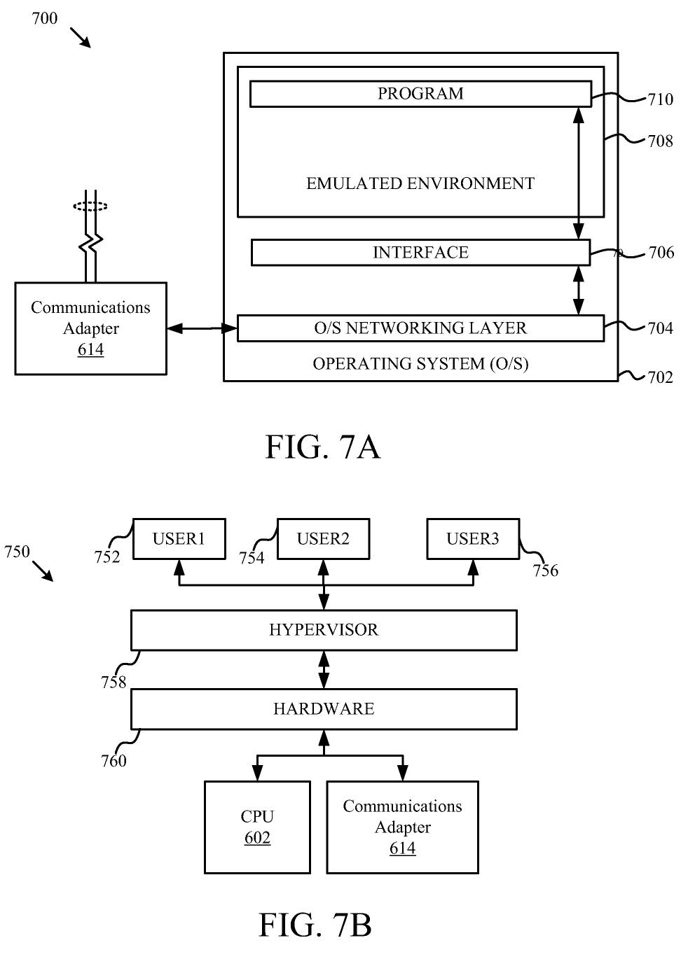

FIG. 7A is a block diagram illustrating a server hosting an emulated software environment for virtualization according to one embodiment of the disclosure. An operating system 702 executing on a server includes drivers for accessing hardware components, such as a networking layer 704 for accessing the communications adapter 614. The operating system 702 may be, for example, Linux. An emulated environment 708 in the operating system 702 executes a program 710, such as CPCommOS. The program 710 accesses the networking layer 704 of the operating system 702 through a non-emulated interface 706, such as XNIOP. The non-emulated interface 706 translates requests from the program 710 executing in the emulated environment 708 for the networking layer 704 of the operating system 702.

In another example, hardware in a computer system may be virtualized through a hypervisor. FIG. 7B is a block diagram illustrating a server hosing an emulated hardware environment according to one embodiment of the disclosure. Users 752, 754, 756 may access the hardware 760 through a hypervisor 758. The hypervisor 758 may be integrated with the hardware 760 to provide virtualization of the hardware 760 without an operating system, such as in the configuration illustrated in FIG. 7A. The hypervisor 758 may provide access to the hardware 760, including the CPU 602 and the communications adaptor 614.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
identifying a first file for backup;
identifying a portion of the first file containing user data; and
copying only the user data portion of the first file to a second file.

2. The method of claim 1, in which the first file is a database file.

3. The method of claim 2, in which the database file is part of a relational database management system (RDMS).

4. The method of claim 3, in which the step of identifying the portion of the first file containing user data comprises identifying a highest-used page number of the database.

5. The method of claim 4, further comprising identifying a current time before identifying the highest-used page number of the database.

6. The method of claim 3, further comprising reporting the highest-used page number to a universal data system control (UDSC), in which the step of copying the user data portion of the first file comprises copying the user data portion of the first file to an intergrated recovery utility (IRU) storing the second file.

7. The method of claim 1, in which the step of identifying the portion of the file containing user data comprises identifying a portion of physical storage allocated to the file but not currently storing user data.

8. A computer program product, comprising:
a non-transitory computer readable medium comprising:
code to identify a first file for backup;
code to identify a portion of the first file containing user data; and
code to copy the user data portion of the first file to a second file.

9. The computer program product of claim 8, in which the first file is a database file.

10. The computer program product of claim 9, in which the database file is part of a relational database management system (RDMS).

11. The computer program product of claim 10, in which the medium comprises code to identify a highest-used page number of the database.

12. The computer program product of claim 11, in which the medium further comprises code to identify a current time before identifying the highest-used page number of the database.

13. The computer program product of claim 11, in which the medium further comprises code to report the highest-used page number to a universal data system control (UDSC).

14. The computer program product of claim 8, in which the medium further comprises code to identify a portion of physical storage allocated to the file but not currently storing user data.

15. An apparatus,
a memory for storing a database; and
a processor coupled to the memory, in which the processor is configured:
to identify a first file of the database for backup;
to identify a portion of the first file containing user data; and
to copy the user data portion of the first file to a second file.

16. The apparatus of claim 15, in which the first file is part of a relational database management system (RDMS).

17. The apparatus of claim 16, in which the processor is configured to identify a highest-used page number of the database.

18. The apparatus of claim 17, in which the processor is configured to report the highest-used page number to a universal data system control (UDSC).

19. The apparatus of claim 15, in which the processor is configured to identify a portion of physical storage allocated to the file but not currently storing user data.

20. The apparatus of claim 15, in which the first file is stored on a first storage device and the second file is stored on a second storage device.
